(19) United States
(12) Patent Application Publication
(10) Pub. No.: US 2018/0158310 A1
(43) Pub. Date: Jun. 7, 2018

(54) Personal Alert and Egress Control Assembly

(71) Applicant: Leroy Sieck, Mobile, AL (US)

(72) Inventor: Leroy Sieck, Mobile, AL (US)

(21) Appl. No.: 15/366,099

(22) Filed: Dec. 1, 2016

(51) Int. Cl. G08B 25/01; G07C 9/00; G08B 25/12

(52) U.S. Cl. CPC G08B 25/016; G07C 2009/00507; G08B 25/12; G07C 9/00309

(57) ABSTRACT

A personal alert and egress control assembly for alerting emergency personnel and controlling access includes a lock unit that is operationally coupled to a door of a residence of a user. A relay unit is operationally coupled to a telephone system of the residence. A signaler is configured to couple to a body of the user. The signaler is configured to selectively wirelessly communicate an emergency alert, a lock command and an unlock command to the relay unit. The relay unit is positioned to wirelessly communicate the lock command and the unlock command to the lock unit. The relay unit also is positioned to compel the telephone system of the residence to communicate the emergency alert to appropriate emergency responders.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### 1. Field of the Invention

### 2. Description of Related Art Including Information Disclosed Under 37 CFR 1.97 and 1.98

The disclosure and prior art relates to control assemblies and more particularly pertains to a new control assembly for alerting emergency personnel and controlling access.

### BRIEF SUMMARY OF THE INVENTION

An embodiment of the disclosure meets the needs presented above by generally comprising a lock unit that is operationally coupled to a door of a residence of a user. A relay unit is operationally coupled to a telephone system of the residence. A signaler is configured to couple to a body of the user. The signaler is configured to selectively wirelessly communicate an emergency alert, a lock command and an unlock command to the relay unit. The relay unit is positioned to wirelessly communicate the lock command and the unlock command to the lock unit. The relay unit also is positioned to compel the telephone system of the residence to communicate the emergency alert to appropriate emergency responders.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is an isometric perspective view of a personal alert and egress control assembly according to an embodiment of the disclosure.

FIG. 2 is a back view of an embodiment of the disclosure.

FIG. 3 is an in-use view of an embodiment of the disclosure.

FIG. 4 is a block diagram of an embodiment of the disclosure.

### DETAILED DESCRIPTION OF THE INVENTION

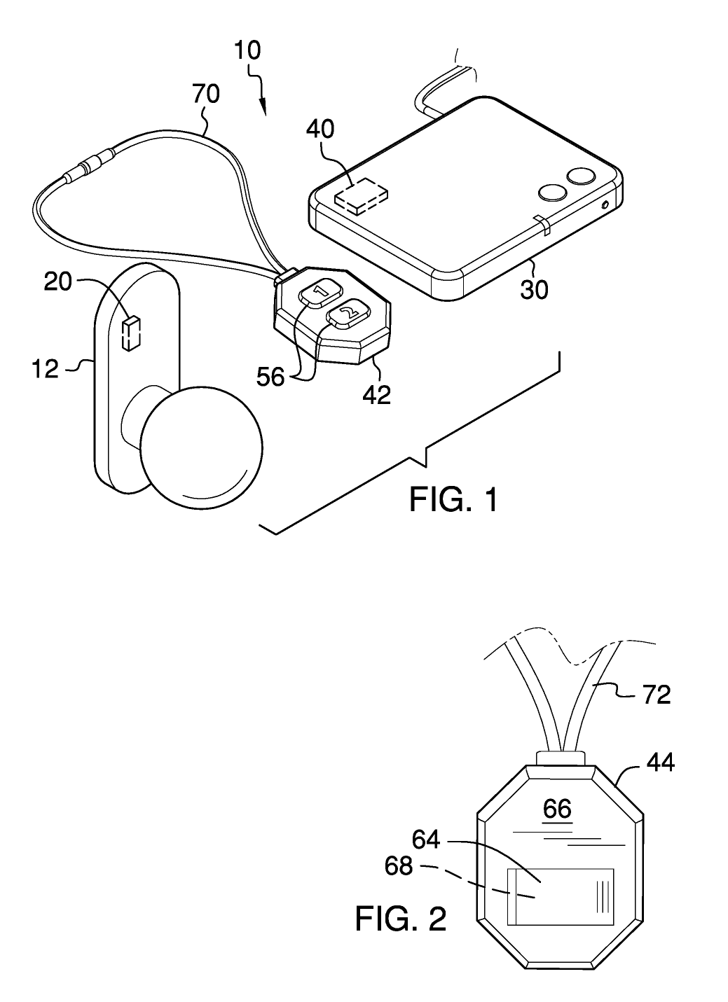

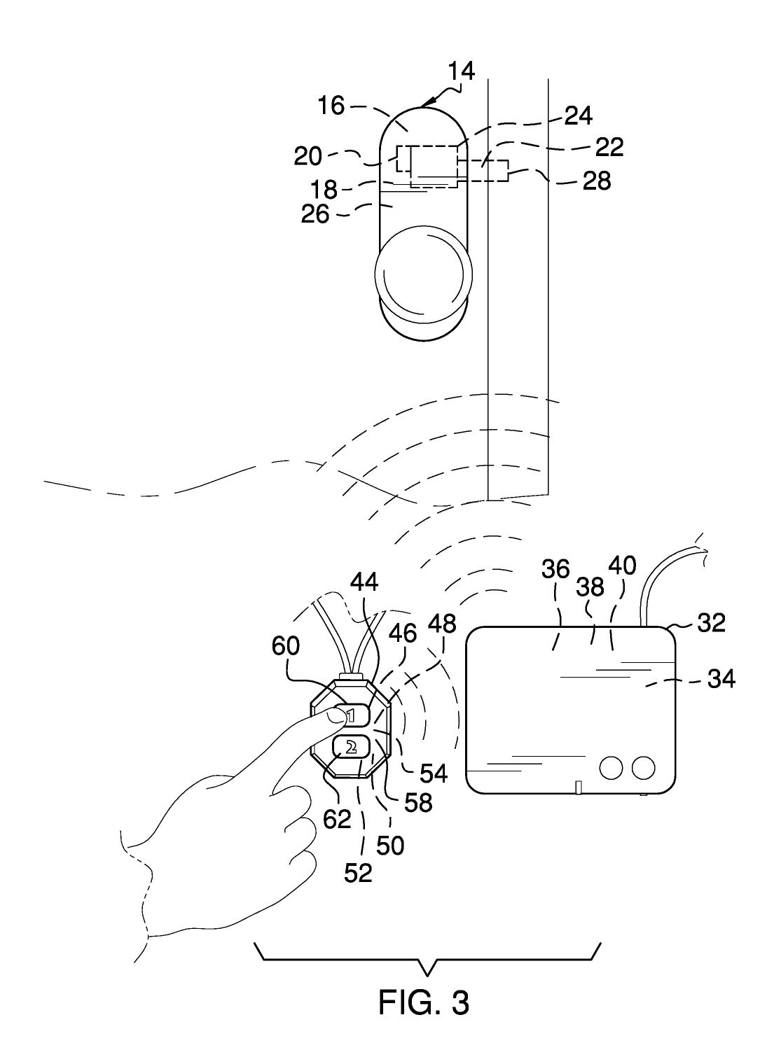

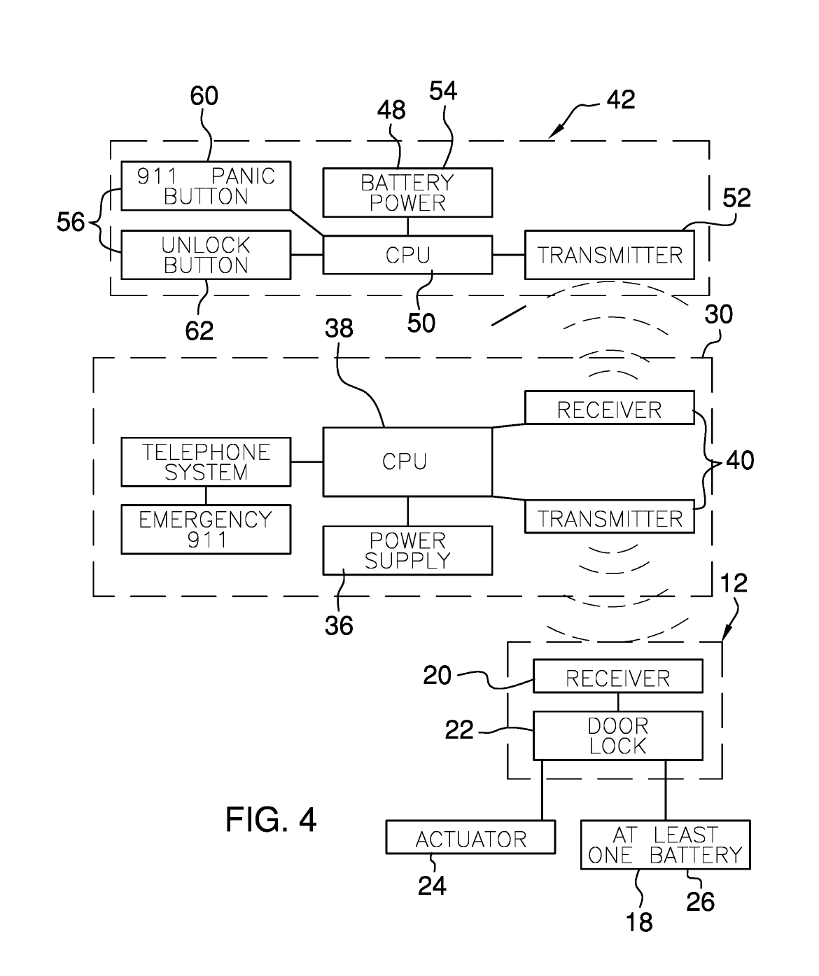

With reference now to the drawings, and in particular to FIGS. 1 through 4 thereof, a new control assembly embodying the principles and concepts of an embodiment of the disclosure and generally designated by the reference numeral 10 will be described.

As best illustrated in FIGS. 1 through 4, the personal alert and egress control assembly 10 generally comprises a lock unit 12 that is operationally coupled to a door of a residence of a user. The lock unit 12 comprises a first housing 14 that defines a first internal space 16. A first power module 18, a receiver 20, a door lock 22 and an actuator 24 are coupled to the first housing 14 and are positioned in the first internal space 16. The receiver 20 is operationally coupled to the first power module 18. The door lock 22 is selectively extendable from the first internal space 16 to reversibly couple to a door frame. The actuator 24 is operationally coupled to the first power module 18, the receiver 20 and the door lock 22. The actuator 24 is positioned to compel the door lock 22 to couple and decouple from the doorframe, wherein the door is selectively locked and unlocked. In one embodiment, the first power module 18 comprises at least one first battery 26. In another embodiment, the door lock 22 comprises a deadbolt 28.

A relay unit 30 is operationally coupled to a telephone system of the residence. The relay unit 30 is configured to wirelessly communicate a lock command and an unlock command to the lock unit 12. The relay unit 30 comprises a second housing 32 that defines a second internal space 34. A second power module 36, a first microprocessor 38 and a transceiver 40 are coupled to the second housing 32 and are positioned in the second internal space 34. The first microprocessor 38 is operationally coupled to the second power module 36. The transceiver 40 is operationally coupled to the first microprocessor 38. The first microprocessor 38 is positioned to compel the transceiver 40 to wirelessly communicate the lock command and the unlock command to the receiver 20. In one embodiment, the second power module 36 comprises an electrical circuit of the residence.

A signaler 42 is configured to couple to a body of the user. The signaler 42 is configured to wirelessly communicate an emergency alert, the lock command and the unlock command to the relay unit 30. The signaler 42 is positioned to selectively send the emergency alert, the lock command and the unlock command to the relay unit 30. The relay unit 30 is positioned to wirelessly communicate the lock command and the unlock command to the lock unit 12. The relay unit 30 also is positioned to compel the telephone system of the residence to communicate the emergency alert to appropriate emergency responders.

The signaler 42 comprises a third housing 44 that defines a third internal space 46. A third power module 48, a second microprocessor 50 and a transmitter 52 are coupled to the third housing 44 and are positioned in the third internal space 46. The second microprocessor 50 is operationally coupled to the third power module 48. The transmitter 52 is operationally coupled to the second microprocessor 50. The second microprocessor 50 is positioned to compel the transmitter 52 to selectively send the emergency alert, the lock command and the unlock command to the first microprocessor 38 via the transceiver 40. The first microprocessor 38 is positioned to compel the telephone system of the residence to communicate the emergency alert to the appropriate emergency responders. The first microprocessor 38 also is positioned to compel the transceiver 40 to wirelessly communicate the lock command and the unlock command to the receiver 20. In one embodiment, the third housing 44 is substantially hexagonally box shaped. In another embodiment, the third power module 48 comprises at least one second battery 54.

A controller 56 is coupled to a front 58 of the third housing 44. The controller 56 is operationally coupled to the second microprocessor 50. The controller 56 is configured to allow entry, by the user, of the emergency alert, the lock command and the unlock command. In one embodiment, the controller 56 comprises a first button 60 and a second button 62. The first button 60 and the second button 62 are depressible. The first button 60 and the second button 62 are configured to be depressed by the user to selectively enter the emergency alert, the lock command and the unlock command.

A panel 64 is couplable to a back 66 of the third housing 44 to reversibly close an opening 68 that is positioned in the back 66. The opening 68 is configured to allow access to the third internal space 46 for replacement of the at least one second battery 54.

A fastener 70 is coupled to and extends from the third housing 44. The fastener 70 is configured to couple the third housing 44 to the body of the user. In one embodiment, the fastener 70 comprises a lanyard 72. The lanyard 72 is configured to position over a head and around a neck of the user to couple the third housing 44 to the body of the user.

In use, the first button 60 and the second button 62 are configured to be depressed by the user to selectively enter the emergency alert, the lock command and the unlock command. The second microprocessor 50 is positioned to compel the transmitter 52 to selectively send the emergency alert, the lock command and the unlock command to the first microprocessor 38 via the transceiver 40. The first microprocessor 38 is positioned to compel the telephone system of the residence to communicate the emergency alert to the appropriate emergency responders. The first microprocessor 38 also is positioned to compel the transceiver 40 to wirelessly communicate the lock command and the unlock command to the receiver 20. The actuator 24 is positioned to compel the door lock 22 to couple and decouple from the doorframe.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

1. A personal alert and egress control assembly comprising:
a lock unit operationally coupled to a door of a residence of a user, said lock unit comprising
a first housing defining a first internal space,
a first power module coupled to said first housing and positioned in said first internal space,
a receiver coupled to said first housing and positioned in said first internal space, said receiver being operationally coupled to said first power module,
a door lock coupled to said first housing and positioned in said first internal space, said door lock being selectively extendable from said first internal space to reversibly couple to a door frame such that the door is selectively locked and unlocked,
an actuator coupled to said first housing and positioned in said first internal space, said actuator being operationally coupled to said first power module, said receiver and said door lock, and
wherein said actuator is positioned in said housing such that said actuator is positioned to compel said door lock to couple and decouple from the door frame;
a relay unit operationally coupled to a telephone system of the residence, said relay unit being configured for wirelessly communicating a lock command and an unlock command to said lock unit, said relay unit comprising:
a second housing defining a second internal space,
a second power module coupled to said second housing and positioned in said second internal space,
a first microprocessor coupled to said second housing and positioned in said second internal space, said first microprocessor being operationally coupled to said second power module,
a transceiver coupled to said second housing and positioned in said second internal space, said transceiver being operationally coupled to said first microprocessor, and
wherein said first microprocessor is positioned in said second housing such that said first microprocessor is positioned to compel said transceiver to wirelessly communicate the lock command and the unlock command to said receiver;
a signaler configured for coupling to a body of the user, said signaler being configured for wirelessly communicating an emergency alert, the lock command and the unlock command to said relay unit, said signaler comprising
a third housing defining a third internal space,
a third power module coupled to said third housing and positioned in said third internal space,
a second microprocessor coupled to said third housing and positioned in said third internal space, said second microprocessor being operationally coupled to said third power module,
a transmitter coupled to said third housing and positioned in said third internal space, said transmitter being operationally coupled to said second microprocessor,
wherein said second microprocessor is positioned in said third housing such that said second microprocessor is positioned to compel said transmitter to selectively send the emergency alert, the lock command and the unlock command to said first microprocessor via said transceiver, wherein said first microprocessor is positioned to compel the telephone system of the residence to communicate the emergency alert to the appropriate emergency responders and wherein said first microprocessor is positioned to compel said transceiver to wirelessly communicate the lock command and the unlock command to said receiver, and
a controller coupled to a front of said third housing, said controller being operationally coupled to said second microprocessor, wherein said controller is positioned on said third housing such that said controller is configured for entering by the user of the emergency alert, the lock command and the unlock command, said controller comprising a first button and a second button, said first button and said second button being depressible, wherein said first button and said second button are positioned on said third housing such that said first button and said second button are configured for depressing by the user to selectively enter the emergency alert, the lock command and the unlock command; and
wherein said signaler is positioned for selectively sending the emergency alert, the lock command and the unlock command to said relay unit, such that said relay unit is positioned for wirelessly communicating the lock command and the unlock command to said lock unit and wherein said relay unit is positioned for compelling the telephone system of the residence to communicate the emergency alert to appropriate emergency responders.

2. (canceled)

3. The assembly of claim 1, further including said first power module comprising at least one first battery.

4. The assembly of claim 1, further including said door lock comprising a deadbolt.

5. (canceled)

6. The assembly of claim 1, further including said second power module comprising an electrical circuit of the residence.

7. (canceled)

8. The assembly of claim 1, further including said third housing being substantially hexagonally box shaped.

9. The assembly of claim 1, further including said third power module comprising at least one second battery.

10. (canceled)

11. (canceled)

12. The assembly of claim 1, further including a panel couplable to a back of said third housing to reversibly close an opening positioned in said back, wherein said opening is positioned in said back such that said opening is configured for accessing said third internal space, such that said at least one second battery is replaceable.

13. The assembly of claim 1, further including a fastener coupled to and extending from said third housing, said fastener being configured for coupling said third housing to the body of the user, wherein said fastener is positioned on said third housing such that said third fastener is configured for coupling said third housing to the body of the user.

14. The assembly of claim 13, further including said fastener comprising a lanyard, wherein said lanyard is positioned on said third housing such that said lanyard is configured for positioning over a head and around a neck of the user, such that said third housing is coupled to the body of the user.

15. A personal alert and egress control assembly comprising:
a lock unit operationally coupled to a door of a residence of a user, said lock unit comprising:
a first housing defining a first internal space,
a first power module coupled to said first housing and positioned in said first internal space, said first power module comprising at least one first battery,
a receiver coupled to said first housing and positioned in said first internal space, said receiver being operationally coupled to said first power module,
a door lock coupled to said first housing and positioned in said first internal space, said door lock being selectively extendable from said first internal space to reversibly couple to a door frame such that the door is selectively locked and unlocked, said door lock comprising a deadbolt, and
an actuator coupled to said first housing and positioned in said first internal space, said actuator being operationally coupled to said first power module, said receiver and said door lock, wherein said actuator is positioned in said housing such that said actuator is positioned to compel said door lock to couple and decouple from the door frame;
a relay unit operationally coupled to a telephone system of the residence, said relay unit being configured for wirelessly communicating a lock command and an unlock command to said lock unit, said relay unit comprising:
a second housing defining a second internal space,
a second power module coupled to said second housing and positioned in said second internal space, said second power module comprising an electrical circuit of the residence,
a first microprocessor coupled to said second housing and positioned in said second internal space, said first microprocessor being operationally coupled to said second power module,
a transceiver coupled to said second housing and positioned in said second internal space, said transceiver being operationally coupled to said first microprocessor, and
wherein said first microprocessor is positioned in said second housing such that said first microprocessor is positioned to compel said transceiver to wirelessly communicate the lock command and the unlock command to said receiver;
a signaler configured for coupling to a body of the user, said signaler being configured for wirelessly communicating an emergency alert, the lock command and the unlock command to said relay unit, wherein said signaler is positioned for selectively sending the emergency alert, the lock command and the unlock command to said relay unit, such that said relay unit is positioned for wirelessly communicating the lock command and the unlock command to said lock unit and wherein said relay unit is positioned for compelling the telephone system of the residence to communicate the emergency alert to appropriate emergency responders, said signaler comprising:
a third housing defining a third internal space, said third housing being substantially hexagonally box shaped,
a third power module coupled to said third housing and positioned in said third internal space, said third power module comprising at least one second battery,
a second microprocessor coupled to said third housing and positioned in said third internal space, said second microprocessor being operationally coupled to said third power module,
a transmitter coupled to said third housing and positioned in said third internal space, said transmitter being operationally coupled to said second microprocessor, and
wherein said second microprocessor is positioned in said third housing such that said second microprocessor is positioned to compel said transmitter to selectively send the emergency alert, the lock command and the unlock command to said first microprocessor via said transceiver, wherein said first microprocessor is positioned to compel the telephone system of the residence to communicate the emergency alert to the appropriate emergency responders and wherein said first microprocessor is positioned to compel said transceiver to wirelessly communicate the lock command and the unlock command to said receiver;
a controller coupled to a front of said third housing, said controller being operationally coupled to said second microprocessor, wherein said controller is positioned on said third housing such that said controller is configured for entering by the user of the emergency alert, the lock command and the unlock command, said controller comprising a first button and a second button, said first button and said second button being depressible, wherein said first button and said second button are positioned on said third housing such that said first button and said second button are configured for depressing by the user to selectively enter the emergency alert, the lock command and the unlock command;
a panel couplable to a back of said third housing to reversibly close an opening positioned in said back, wherein said opening is positioned in said back such that said opening is configured for accessing said third internal space, such that said at least one second battery is replaceable;
a fastener coupled to and extending from said third housing, said fastener being configured for coupling said third housing to the body of the user, wherein said fastener is positioned on said third housing such that said third fastener is configured for coupling said third housing to the body of the user, said fastener comprising a lanyard, wherein said lanyard is positioned on said third housing such that said lanyard is configured for positioning over a head and around a neck of the user, such that said third housing is coupled to the body of the user; and
wherein said lanyard is positioned on said third housing such that said lanyard is configured for positioning over a head and around a neck of the user, such that said third housing is coupled to the body of the user, wherein said first button and said second button are positioned on said third housing such that said first button and said second button are configured for depressing by the user to selectively enter the emergency alert, the lock command and the unlock command, such that said second microprocessor is positioned to compel said transmitter to selectively send the emergency alert, the lock command and the unlock command to said first microprocessor via said transceiver, wherein said first microprocessor is positioned to compel the telephone system of the residence to communicate the emergency alert to the appropriate emergency responders and wherein said first microprocessor is positioned to compel said transceiver to wirelessly communicate the lock command and the unlock command to said receiver, such that said actuator is positioned to compel said door lock to couple and decouple from the doorframe.
